(19) United States
(12) Patent Application Publication
(10) Pub. No.: US 2013/0264073 A1
(43) Pub. Date: Oct. 10, 2013

(54) Integrated Thermal Event Suppression Apparatus

(71) Applicant: Greg Ling, Aliso Viejo, CA (US)

(72) Inventor: Greg Ling, Aliso Viejo, CA (US)

(21) Appl. No.: 13/442,883

(22) Filed: Apr. 10, 2012

(51) Int. Cl. A62C 3/07; H01M 2/02

(52) U.S. Cl. CPC A62C 3/07; H01M 2/0237
USPC 169/46; 429/62

(57) ABSTRACT

A method of suppressing thermal event for an automotive battery pack having a thermal event suppression apparatus attached to said battery pack; wherein said suppression apparatus has a nozzle that sprays a fire extinguishing media, and having said nozzle extended into a housing of said battery pack; and wherein said suppression apparatus has a thermal event detector to detect a threshold temperature, and said detector triggers a valve to open, allowing said nozzle to spray said media into the housing.

### BACKGROUND OF THE INVENTION

(1). Field of the Invention

The subject matter described herein generally relates to thermal event suppression and more particularly relates to thermal event suppression in high voltage batteries used in such things as hybrid and electric cars.

(2). Description of Related Art

Modernly, with the increased costs of fuel and the rising environmental concerns, many individuals now choose to drive automobiles such as hybrid and electric cars (hereafter referred together as “hybrid”). Hybrid cars have become very popular as an alternative to regular gasoline traditional based cars.

With the advancement of technology, many hybrid vehicles contain high voltage batteries which enable them to perform their function of powering hybrid vehicles. Contained within high voltage batteries are cells that typically contain chemical fluids and materials which store and release energy in the form of electricity to provide power to the vehicle.

In certain cases involving accidents resulting in impact with another vehicle, the high voltage batteries may become damaged whereby the chemical fluids and materials previously residing in the high voltage battery cells are released into the environment and may cause a highly dangerous situation due to its flammable composition.

Desirable features will become apparent from the subsequent detailed description and the appended claims, taken in conjunction with the accompanying drawings and the foregoing technical field and background.

All referenced patents, applications and literature are incorporated herein by reference to their entirety. Furthermore, where a definition or use of a term in a reference, which is incorporated by reference herein, is inconsistent or contrary to the definition of that term provided herein, the definition of that term provided herein applies and the definition of the term in the reference does not apply. The invention may seek to satisfy one or more of the above-mentioned desires. Although the present invention may obviate one or more of the above-mentioned desires, it should be understood that some aspects of the invention might not necessarily obviate them.

### BRIEF SUMMARY OF THE INVENTION

In view of the foregoing disadvantages inherent in the known types of prior art, the general purpose of the present invention, which will be described subsequently in greater detail, is to provide a thermal event suppression apparatus for an automotive battery pack comprising a fire extinguishing media case; a fire extinguishing medial enclosed within said media case; a spray nozzle; and a conduit fluidly connecting said media case to said nozzle, and wherein said nozzle is adapted to be enclosed within a housing of the battery pack.

It is a feature of this invention to provide a method of suppressing thermal event for an automotive battery pack having an integrated thermal event suppression apparatus attached to said battery pack; wherein said suppression apparatus has a nozzle that sprays a fire extinguishing media, and having said nozzle extended into a housing of said battery pack; and wherein said suppression apparatus has a thermal event detector to detect a threshold temperature, and said detector triggers a valve to open, allowing said nozzle to spray said media into the housing.

Another feature of this invention is to provide an improved method of extinguishing a fire in a high voltage battery;

Another feature of this invention is to reduce the time between when the thermal trigger event occurs and when the thermal event is suppressed resulting from a high voltage battery being damaged in an accident;

Another feature of the invention is to provide a cost-effective method and apparatus to treat fires resulting from damage to a high voltage battery;

Another feature of the invention is to provide a thermal event suppression apparatus that automatically detects when a thermal triggering event occurs and automatically suppresses the thermal event.

Other details, features, uses, objects and advantages of this invention will become apparent from the embodiments thereof presented in the following specification, claims, and drawings.

This summary is provided to introduce a selection of concepts in a simplified form that are further described below in the detailed description. This summary is not intended to identify key features or essential features of the claimed subject matter; nor is it intended to be used as an aid in determination the scope of the claimed subject matter.

### DESCRIPTION OF THE DRAWING(S)

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 shows a first embodiment where the valve and the thermal event detector (e.g., metallic strip) inside of the battery housing.

FIG. 2 shows a second embodiment where the valve and the thermal event detector (e.g., metallic strip) outside of the battery housing.

FIG. 3 shows a third embodiment using an electrical control unit, where the thermal sensor is outside of the battery housing.

FIG. 4 shows a fourth embodiment using an electrical control unit, where the thermal sensor is inside of the battery housing.

FIG. 5 is a specific example of embodiment 1 of FIG. 1.

### DESCRIPTION OF AN EXEMPLARY EMBODIMENT

The following detailed description is merely exemplary in nature and is not intended to limit the inventive subject matter or the application and uses of the inventive subject matter. Furthermore, there is no intention to be bound by any theory presented in the preceding background or the following description. Techniques and technologies may be described herein in terms of functional and/or logical block components and various processing steps. It should be appreciated that such block components may be realized by any number of hardware, software, and/or firmware components configured to perform the specified functions. In addition, those skilled in the art will appreciate that embodiments may be practiced in conjunction with any number of ways and that the apparatus and method described herein is merely one suitable example.

Many alterations and modifications may be made by those having ordinary skill in the art without departing from the spirit and scope of the invention. Therefore, it must be understood that the exemplary embodiment has been set forth only for the purposes of example and that it should not be taken as limiting the invention as defined by the following claims. For example, notwithstanding the fact that the elements of a claims are set forth below in a certain combination, it must be expressly understood that the invention includes other combinations of fewer, more or different elements, which are disclosed herein even when not initially claimed in such combinations.

Furthermore, the connecting lines shown in the various figures contained herein are intended to represent example functional relationships and/or physical couplings between the various elements. It should be noted that many alternative or additional functional relationships or physical connections may be present in an embodiment of the subject matter.

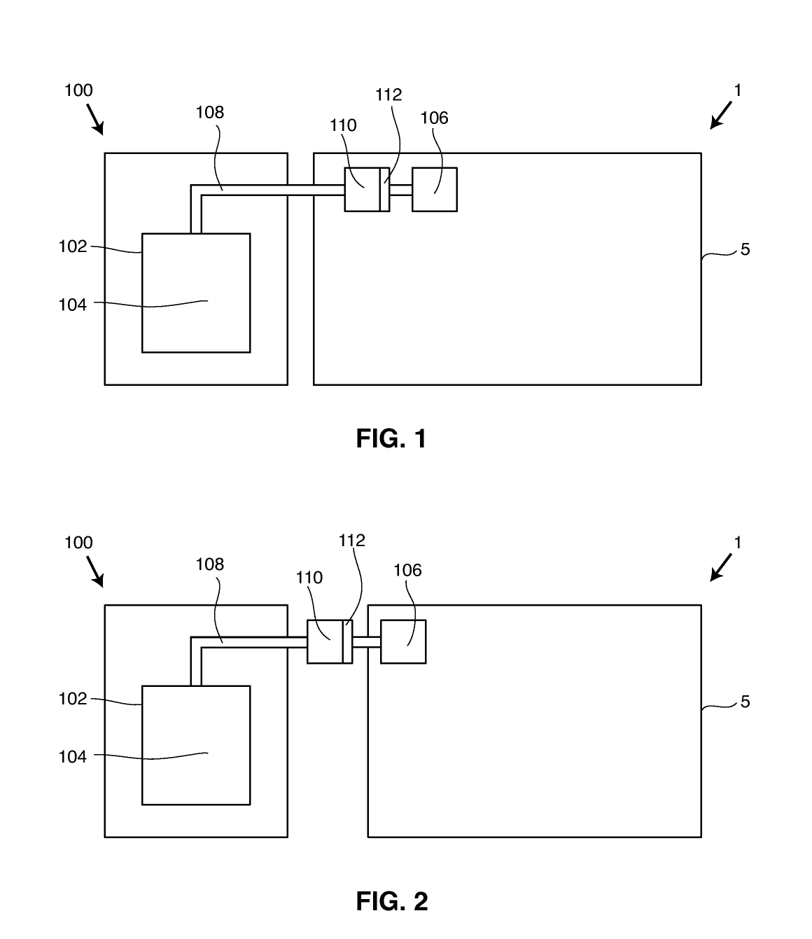

Referring now to the drawings, which are provided by way of illustration and example, and wherein like reference numerals designate like or corresponding elements among the several views, there is shown in FIG. 1, an integrated thermal event suppression apparatus comprising a battery pack 1, housing of the battery pack 5, a fire extinguisher media case 102, a fire extinguishing media 104, a nozzle 106, a conduit 108, a thermal event detector 110, and a valve, or flow control device for embodiments using an electrical control unit 112. In this drawing view, the valve, or flow control device for embodiments using an electrical control unit 112 and metallic strip (not shown) are positioned inside the housing of the battery pack 5. FIG. 2 shows a second embodiment where the valve or flow control device for embodiments using an electrical control unit 112 and metallic strip (not shown), can be positioned outside the housing of the battery pack 5.

In both FIGS. 1 and 2, the thermal event suppression apparatus 100 comprises a fire extinguishing media case 102 which contains a fire extinguishing media 104 that has properties and features that are able to put out thermal events such as a fire resulting from the high voltage battery being damaged. In one embodiment, said fire extinguishing media 104 can consists of at least one of a class A type, class B type, class C type, and class D type fire extinguisher. In one embodiment, the fire extinguishing media can be comprised of Halon or Halon-like properties.

In the present embodiment, the valve 112 is coupled to a nozzle 106 which is adapted to spray or release the said fire extinguishing media 104 upon the internal components of the housing of the battery pack 5. A conduit 108 fluidly connects the said fire extinguishing media case 102 to the said nozzle 106 to allow for proper transfer of the fire extinguishing media 104 from the fire extinguishing case 102 to the housing of the battery pack 5. In the embodiment illustrated in FIGS. 1 and 2, the thermal event detector 110 can be a metallic strip that controls the opening of the valve 112 based on a temperature surrounding the metallic strip. In one practicing embodiment, once the temperature surrounding the metallic strip reaches a certain temperature, the metallic strip 111 is melted and the valve 112 on the thermal event detector 110 is opened resulting in the flow of the fire extinguishing media 104 from the fire extinguishing case 102 allowing the nozzle 106 to spray the fire extinguishing media 104 into the housing of the battery pack 5.

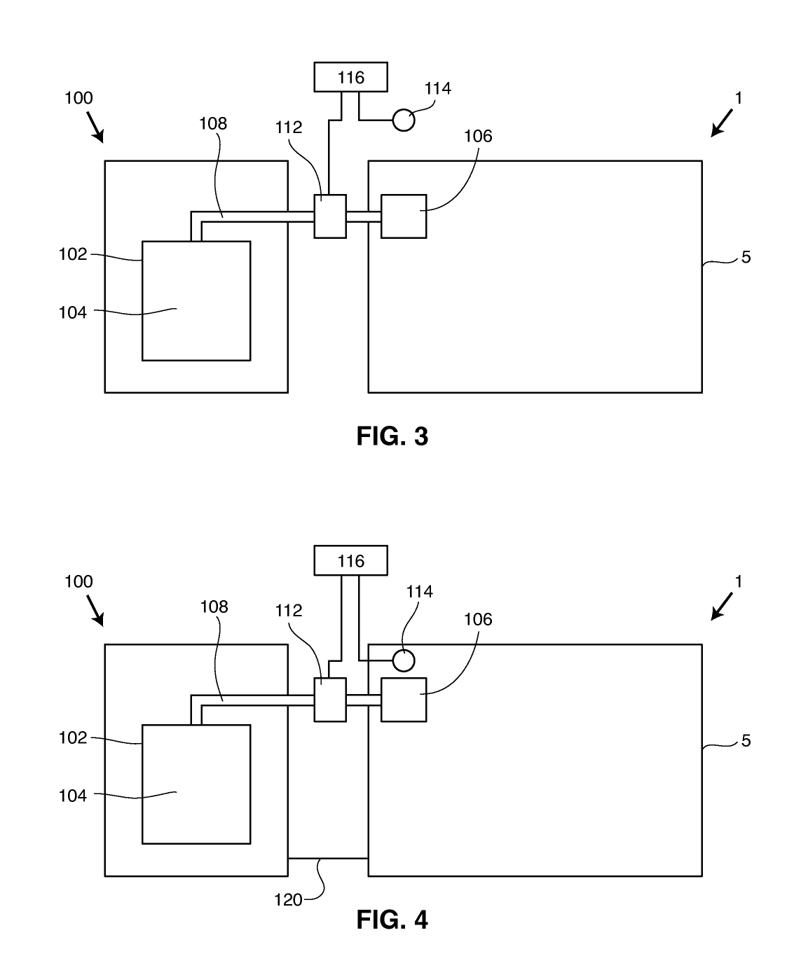

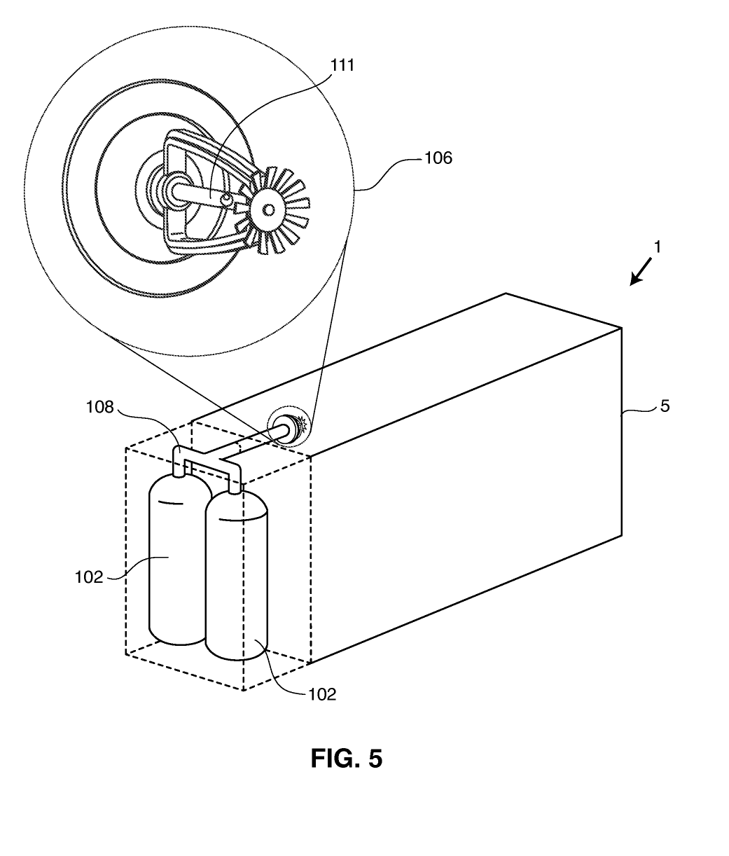

In FIG. 3, another embodiment of the thermal event suppression apparatus 100 are shown comprising a fire extinguishing media case 102 which contains a fire extinguishing media 104 that has properties and features that are able to put out thermal events such as a fire resulting from the high voltage battery being damaged. In one embodiment, said fire extinguishing media 104 can consists of at least one of a class A type, class B type, class C type, and class D type fire extinguisher. In one embodiment, the fire extinguishing media can be comprised of Halon or Halon-like properties. In the present embodiment, the valve 112 is coupled to a nozzle 106 which is adapted to spray or release the said fire extinguishing media 104 upon the internal components of the housing of the battery pack 5. A conduit 108 fluidly connects the said fire extinguishing media case 102 to the said nozzle 106 to allow for proper transfer of the fire extinguishing media 104 from the fire extinguishing case 102 to the housing of the battery pack 5. In the embodiment illustrated in FIGS. 3 and 4, the thermal event detector is a thermal sensor 114 that is coupled to an electrical control unit 116. The thermal sensor 114 triggers the electrical control unit 116 when the thermal sensor 114 senses a temperature over a specific threshold making the valve or flow control device for embodiments using an electrical control unit 112 opening resulting in the flow of the fire extinguishing media 104 from the fire extinguishing case 102 allowing the nozzle 106 to spray the fire extinguishing media 104 into the housing of the battery pack 5. FIG. 4 shows an alternate embodiment where the thermal sensor 114 is positioned inside the housing of battery pack 5. FIG. 5 shows another alternative embodiment thermal event suppression apparatus 100 further including an attachment support to attach the fire extinguishing media case on one side of the housing of the battery pack 5. An exploded view of the nozzle 106 and an embodiment of the thermal event detector as a metallic strip 111 coupled to the conduit 108 which is fluidly connects the fire extinguishing media case 102 to said nozzle 106 wherein said nozzle 106 is adapted to be enclosed within a housing of the battery pack 1.

In an example of a typical application of an exemplary embodiment, a hybrid vehicle containing a high voltage battery is involved in an automobile accident causing one or more of the battery cells contained within the high voltage battery pack 1 to be damaged resulting in the interior of the housing of the battery pack 5 being compromised. In one contemplated scenario, the battery pack 1 catches on fire due to battery chemical fluids leaking out and coming into contact with exposed electricity from the automobile due to accident damage. Upon such thermal event occurring, the thermal event detector 110 in the form of a metallic strip 111 or other thermal sensor 114, triggers the valve or flow control device for embodiments using an electrical control unit 112 to open resulting in the flow of the fire extinguishing media 104 from the fire extinguishing case 102 through the conduit 108 allowing the nozzle 106 to spray the fire extinguishing media 104 into the housing of the battery pack 5 quenching or otherwise suppressing the chemical based fire.

Thus, specific embodiments and applications of the have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A thermal event suppression apparatus for an automotive battery pack comprising:
a fire extinguishing media case;
a fire extinguishing media enclosed within said media case;
a spray nozzle;
a conduit fluidly connecting said media case to said nozzle, and wherein said nozzle is adapted to be enclosed within a housing of the battery pack;
a thermal event detector coupled to the conduit, wherein the thermal event detector controls the opening of a valve in the conduit based on a temperature surrounding the thermal event detector.

2. The apparatus of claim 1, wherein the nozzle is adapted to spray said media within said housing of the battery pack.

3. The apparatus of claim 2, wherein the thermal event detector is a metallic strip detector, and wherein a metallic strip in the detector melts under a specific heat threshold.

4. The apparatus of claim 2, wherein the thermal event detector has a thermal sensor, said thermal sensor is connected to an electrical control unit.

5. The apparatus of claim 4, wherein the thermal sensor triggers the electrical control unit when the thermal sensor senses a temperature over a specific threshold.

6. The apparatus of claim 2, further including an attachment support to attach the extinguishing media case on one side of the housing of the battery pack.

7. The apparatus of claim 1, wherein the fire extinguishing media is at least one of a class A type, class B type, class C type, and class D type fire extinguisher.

8. The apparatus of claim 7, wherein the fire extinguishing media is at least one of a class C type, and class D type fire extinguisher.

9. The apparatus of claim 1, wherein the fire extinguishing media is Halon.

10. A method of suppressing thermal event for an automotive battery pack comprising:
having a thermal event suppression apparatus attached to said battery pack;
wherein said suppression apparatus has a nozzle that sprays a fire extinguishing media, and having said nozzle extended into a housing of said battery pack; and
wherein said suppression apparatus has a thermal event detector to detect a threshold temperature, and said detector triggers a valve to open, allowing said nozzle to spray said media into the housing.

12. The method of claim 11, wherein the detector is a metallic strip detector.

13. The method of claim 11, wherein the detector is a thermal sensor.

14. The method of claim 13, wherein the thermal sensor is connected to an electrical control unit that controls said valve.

15. The method of claim 11, wherein the fire extinguishing media is at least one of a class A type, class B type, class C type, and class D type fire extinguisher.

16. The method of claim 15, wherein the fire extinguishing media is at least one of a class C type, and class D type fire extinguisher.

17. The method of claim 16, wherein the fire extinguishing media is Halon.

18. The method of claim 11, further comprising the step of providing said thermal sensor within said housing of the battery pack.

19. The method of claim 11, further comprising the step of providing said thermal sensor outside of said housing of the battery pack.
